(19) United States
(12) Patent Application Publication
(10) Pub. No.: US 2025/0297950 A1
(43) Pub. Date: Sep. 25, 2025

(54) DYNAMIC CORRECTION FOR LEAKAGE CURRENT AND BACKGROUND RADIATION

(71) Applicant: APPLIED MATERIALS, INC., Santa Clara, CA (US)

(72) Inventors: USMAN CHOWDHURY, Santa Clara, CA (US); ABDULLAH ZAFAR, Santa Clara, CA (US); WILLIAM J. DURAND, San Francisco, CA (US); MARIO DANIEL SANCHEZ, Santa Clara, CA (US); FARZAD HOUSHMAND, Mountain View, CA (US); KASTURI SARANG, San Jose, CA (US); AUNG TOE, Newton, MA (US); JOSHUA JONES, Santa Clara, CA (US); AMIR BAYATI, San Jose, CA (US)

(21) Appl. No.: 18/749,288

(22) Filed: Jun. 20, 2024

Related U.S. Application Data
(60) Provisional application No. 63/567,395, filed on Mar. 19, 2024.

(51) Int. Cl. G01N 21/3504

(52) U.S. Cl. CPC G01N 21/3504

(57) ABSTRACT

Embodiments disclosed herein include a sensor apparatus that includes a gas cell-body with a first end and a second end, and a light source coupled to the first end of the gas cell-body, where the light source is configured to emit electromagnetic radiation through the gas cell-body. In an embodiment, the sensor apparatus further includes a photonic detector system coupled to the second end of the gas cell-body, and a housing around the gas cell-body that is temperature controlled, where the photonic detector is outside the housing. The sensor apparatus may further include a temperature sensor configured to measure a temperature of the photonic detector system or a temperature of the gas cell-body.

### CROSS-REFERENCE TO RELATED APPLICATIONS

This application claims the benefit of U.S. Provisional Application No. 63/567,395, filed on Mar. 19, 2024, the entire contents of which are hereby incorporated by reference herein.

### BACKGROUND

### 1) Field

Embodiments of the present disclosure pertain to the field of dynamic calibration processes for photonic sensors.

### 2) Description of Related Art

The fabrication of microelectronic devices, display devices, micro-electromechanical systems (MEMS), and the like require the use of one or more processing chambers. For example, processing chambers such as, but not limited to, an atomic layer deposition (ALD) chamber, a plasma enhanced chemical vapor deposition chamber, a physical vapor deposition chamber, or a plasma treatment chamber may be used to fabricate various devices. As scaling continues to drive to smaller critical dimensions in such devices, the need for uniform processing conditions (e.g., uniformity across a single substrate, uniformity between different lots of substrates, and uniformity between chambers in a facility) as well as process stability during the process are becoming more critical in high volume manufacturing (HVM) environments.

Processing non-uniformity and non-stability arise from many different sources. One such source is the species concentration variability of vaporized precursors. That is, as substrates are processed in a chamber, the precursor source dosage is reduced. In some instances, a photonic sensor is used to monitor the concentration of species within a gas that is flown into the chamber. However, photonic sensors are susceptible to drift as a result of multiple environmental factors. For example, thermal leakage current and stray or background infrared radiation can cause the accuracy of the photonic sensor to drift. Accordingly, photonic sensors must typically operate in a narrow and well-defined temperature range in order to yield adequate accuracy of concentration measurements.

### SUMMARY

Embodiments disclosed herein include a sensor apparatus that includes a gas cell-body with a first end and a second end, and a light source coupled to the first end of the gas cell-body, where the light source is configured to emit electromagnetic radiation through the gas cell-body. In an embodiment, the sensor apparatus further includes a photonic detector system coupled to the second end of the gas cell-body, and a housing around the gas cell-body that is temperature controlled, where the photonic detector is outside the housing. The sensor apparatus may further include a temperature sensor configured to measure a temperature of the photonic detector system or a temperature of the gas cell-body.

Embodiments disclosed herein may also include a method for generating a calibrated intensity signal that includes flowing a gas through a sensor that includes a temperature sensor on a photo-detector system of the sensor, and detecting an intensity signal with the sensor. In an embodiment, the method further includes calibrating the intensity signal by applying a calibration model to the intensity signal to produce the calibrated intensity signal. In an embodiment, the calibration model depends at least partially on a temperature measured by the temperature sensor.

Embodiments disclosed herein may also include a method for controlling the flow of gas into a chamber. In an embodiment, the method includes flowing a gas through an ampule to a chamber, and monitoring a concentration of a species in the gas with a photonic sensor that includes one or more temperature sensors to control for effects of leakage current and/or background radiation in the photonic sensor. In an embodiment, leakage current may also include dark current. As used herein, references to “leakage current” may also include a reference to “dark current”. In an embodiment, the method further includes changing a temperature of the ampule to maintain the concentration of the species in the gas in response to deviations of the concentration of the species in the gas detected by the photonic sensor.

### BRIEF DESCRIPTION OF THE DRAWINGS

FIG. 1 is a schematic illustration of an ampoule for holding a volatile precursor, in accordance with an embodiment of the present disclosure.

FIG. 2 is a plot of absorbance as a function of time for a single pulse of gas passing through a photonic sensor, in accordance with an embodiment of the present disclosure.

FIG. 3 is a plot of on-film performance as a function of time for a constant ampoule temperature, in accordance with an embodiment of the present disclosure.

FIG. 4 is a plot of on-film performance as a function of time for an increasing or upward ramping ampoule temperature, in accordance with an embodiment of the present disclosure.

FIG. 5A is a plot of signal magnitude over time through a plurality of pulses, in accordance with an embodiment of the present disclosure.

FIG. 5B is a plot of the absorbance over the same time as shown in FIG. 5A, in accordance with an embodiment of the present disclosure.

FIG. 6 is a schematic illustration of a photonic sensor, in accordance with an embodiment of the present disclosure.

FIG. 7 is a schematic illustration of a photonic sensor, in accordance with an embodiment of the present disclosure.

FIG. 8 is a schematic illustration of a photonic sensor with a plurality integrated temperature sensors for enabling dynamic correction for leakage current and/or background radiation, in accordance with an embodiment of the present disclosure.

FIG. 9 is a plot of a raw data line of an intensity signal of the photonic sensor and a corresponding calibrated intensity signal using a single parameter correction or a multi-parameter correction, in accordance with an embodiment of the present disclosure.

FIG. 10 is a process flow diagram of a process for calibrating an intensity signal with a single parameter correction model, in accordance with an embodiment of the present disclosure.

FIG. 11 is a process flow diagram of a process for calibrating an intensity signal with a multi-parameter correction model, in accordance with an embodiment of the present disclosure.

FIG. 12 is a process flow diagram of a process for controlling an ampule temperature to provide a uniform species concentration to a chamber, in accordance with an embodiment of the present disclosure.

FIG. 13 illustrates a block diagram of an exemplary computer system of a processing tool, in accordance with an embodiment of the present disclosure.

### DETAILED DESCRIPTION

Described herein are photonic sensors configured to provide dynamic (or real-time) correction, compensation, and/or calibration in order to account for the corresponding change to the leakage current and/or stray radiation that would otherwise alter the magnitude of the intensities and the corresponding concentration values. As a result, the photonic sensor readings of species concentration will be accurate even when the ambient temperature varies significantly.

In an embodiment, the dynamic correction is implemented through the use of mathematical modeling that can be used to find characteristic fit values for the one or more temperature readings from these additional temperature sensors. For example, a calibration model that is dependent on the readings of one or more of the temperature sensors is applied (e.g., through addition, subtraction, multiplication, division, etc.) to the intensity signal in order to provide the dynamic correction. The calibration model may be a linear function or a non-linear function of the temperature, depending on how many parameters are used and how the various terms are arranged in the mathematical models. In some instances, increasing the number of terms with the same parameters but in different algebraic combinations (such as, introducing exponential, logarithmic, correlation, or products of multiple parameters) in the calibration model may increase the resulting accuracy of the photonic sensor.

In an embodiment, the dynamic correction may be applied by a controller through software, firmware, hardware, or any combination thereof. In an embodiment, the controller may be part of the photonic sensors system. For example, the controller may reside on a board (such as a printed circuit board (PCB)) that is coupled to the photonic detector of the photonic detector system. Though, the controller may also be external to the photonic sensor.

In an embodiment, the photonic sensor may include any type of sensor capable of monitoring the concentration of a species within a gas that is flown through the photonic sensor. In a particular embodiment, the photonic sensor is a non-dispersive infrared (NDIR) optical absorption sensor. Suitable high sensitivity NDIR sensors may be enabled by an actively cooled, passively cooled, or uncooled HgCdTe (MCT) detector that is coupled with a thermally isolated gas cell-body. Embodiments may also be applicable to sensors operating at other wavelengths of the electromagnetic spectrum, including a non-dispersive ultraviolet (NDUV) optical absorption sensor.

Particularly, the photonic sensor may include a photon (light) source (e.g., an infrared (IR) light source, an ultraviolet (UV) light source, or any other suitable photon source) and a photo-detector. As the gas flows through a gas cell-body of the photonic sensor, electromagnetic radiation (e.g., IR radiation) from the light source is absorbed by the species within the gas. That is a higher concentration of the species will result in a decrease in the amount of light that reaches the photo-detector. Changes to the magnitude of the intensity signal detected by the photonic detector can be correlated to a concentration of the species through the Beer-Lambert Law shown in Equation 1.

$$Absorbance = C * ε * l = - {log}_{10} ( \frac{ϕ}{{ϕ}_{0}} ) \qquad Equation l$$

In Equation 1, C is the concentration, ϵ is the molar absorptivity, l is the optical path length, ϕ is the photon intensity with a species within the gas cell-body, and ϕ₀ is the photon intensity without the species inside the gas cell-body. That is, the optical signal can be converted to an absorbance, where the intensity is proportional to the concentration of the species.

Advantages or improvements for implementing embodiments described herein can include one or more of (1) providing proper calibration independent of temperature, (2) the ability to provide continuous monitoring as opposed to relying on a pulsed operation, and/or (3) the ability to omit expensive phased-locking detection systems.

To provide context, rates of thin-film processes and some etching processes are correlated with precursor concentrations delivered to reactors. Typically, delivered concentration is only inferred from on-wafer thickness or other indirect measurements. Existing sensors suffer from poor signal to noise ratio (SNR), unable to differentiate changes in process conditions or drift. Processes can benefit from a more sensitive photonic sensor that can operate at the low pressures, high temperatures, and low concentrations (<1 mol %) typical of semiconductor processes.

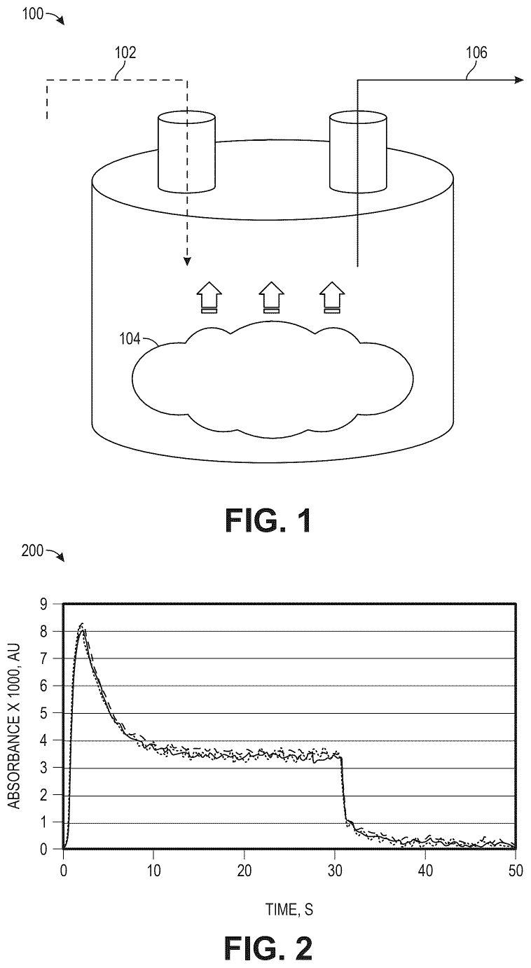

As can be appreciated, low-volatility chemical precursors have complex delivery characteristics. FIG. 1 illustrates a schematic of an ampoule for holding a volatile precursor, in accordance with an embodiment of the present disclosure.

Referring now to FIG. 1, an ampoule 100 includes a carrier gas inlet 102, a storage area for a volatile precursor 104, and a carrier gas/precursor outlet 106. As a carrier gas is flown into the ampoule 100 through the carrier gas inlet 102, the volatile precursor 104 is mixed and “carried” with the carrier gas out of the gas/precursor outlet 106. It is to be appreciated that the amount of the volatile precursor 104 that is removed from the ampoule 100 is dependent on many factors, such as, but not limited to, the flow rate of the carrier gas and/or a temperature of the ampoule 100. For example, heating the ampoule 100 with a heater (not shown) may increase the concentration of volatized precursor 104 in order to allow for a higher concentration of the precursor gas species in the carrier gas/precursor mixture that exits the outlet 106 towards a photonic sensor and a processing chamber.

Referring now to FIG. 2 a plot 200 of absorbance as a function of time, is shown, in accordance with an embodiment. Plot 200 depicts an individual pulse of the carrier gas/precursor mixture exiting the outlet 106. As shown, the concentration varies as a function of time due to the physics of the mass transport. That is, the vapor of the volatile precursor 104 builds up in a closed system before the pulse begins. When the pulse starts, the absorbance is high due to higher concentrations of the volatile precursor 104 as shown in FIG. 1. The complex dynamics of injecting a dry gas (i.e., the carrier gas) and continuous exhaustion of through the ampoule outlet 106 can result in a decreasing concentration of the precursor species that eventually levels off over the remaining duration of the pulse.

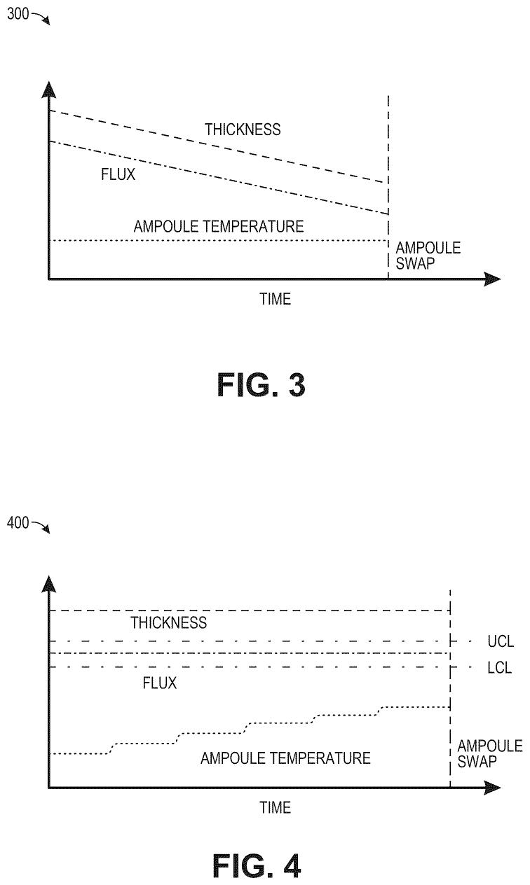

FIG. 3 is a plot 300 of on-film performance as a function of time for a constant ampoule temperature, in accordance with an embodiment.

Particularly, FIG. 3 shows a plot of long-term performance changes, where the dose (sum total of mass injected to the chamber) decreases as the output from the ampoule 100 changes due to many factors. For example, as the liquid or solid volume of the precursor 104 decreases over time, the concentration of the precursor vapor provided to the chamber decreases with all other variables held substantially constant. As a result the deposition rate (e.g., thickness) decreases over time along with the decreasing flux of the precursor 104 provided to the chamber. At a certain point, the deposition rate falls out of specification, and the ampoule 100 will be swapped out for a new ampoule 100.

Processing efficiency can demand improved productivity, improved yield, and improved ampoule utilization (e.g., precursor availability optimization). FIG. 4 is a plot 400 of on-film performance as a function of time for an increasing or upward ramping ampoule 100 temperature, in accordance with an embodiment. The temperature increase compensates for the depletion of the precursor 104 within the ampoule 100. Accordingly, the thickness remains substantially constant, and the flux remains between a lower control limit (LCL) and an upper control limit (UCL).

However, it is to be appreciated that the plot 400 is idealized. That is, the temperature increases to the ampoule 100 provide a near perfect response to the flux of the precursor into the processing chamber. This relies on a very high precision reading of the precursor concentration by the photonic sensor in order to determine what temperature the ampoule 100 needs to be set at. However, as described above, existing photonic sensors may not provide this level of accuracy. The limited accuracy may be due, at least in part, to the presence of leakage current and/or stray IR radiation.

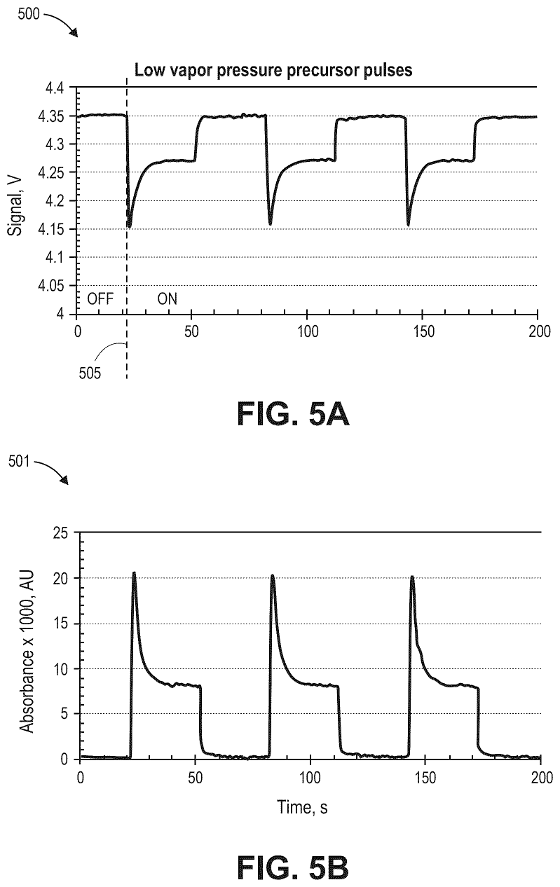

Referring now to FIGS. 5A and 5B, a plot 500 of the intensity signal over time and a plot 501 of the calculated absorbance are shown, in accordance with an embodiment. As shown, the signal is relatively high and constant during an “off” condition (e.g., before line 505), and a rapid decrease in signal is seen at the start of an “on” condition (e.g., after line 505). The on condition (i.e., the pulse length) continues until approximately 50 seconds. Over the duration of the pulse, the value of the intensity signal increases until it plateaus approximately ten seconds into the pulse. At the end of the pulse, the signal increases back to the level of the “off” condition from the start of the cycle. Similarly, the calculated absorbance is at 0 until the start of the pulse. The absorbance has a rapid increase until plateauing before the end of the pulse. The total flux (or dose) can be determined by integrating the pulsed curve over the duration of the pulses. It is to be appreciated that the specific pulse durations and periods between pulses are exemplary in nature. For example, pulse durations may be up to 60 seconds, up to 30 seconds, up to 10 seconds, up to 1.0 second, or up to 0.5 seconds. Though, embodiments may include pulses of any duration in order to achieve a desired processing result on a substrate within a chamber.

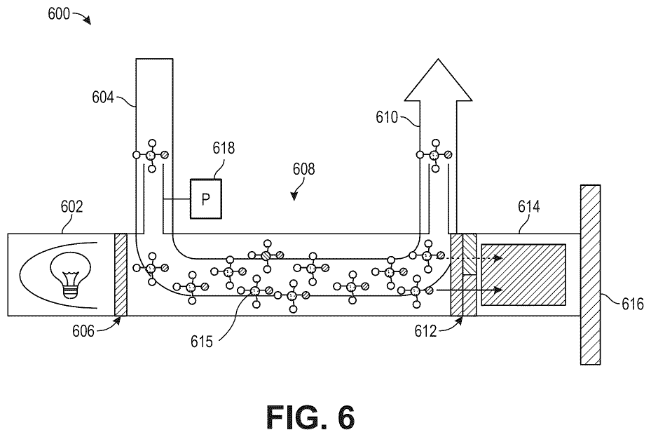

In an embodiment, NDIR optical absorption can be implemented to perform vapor concentration sensing. That is, a concentration of a precursor species in a gas may be calculated through the use of an NDIR sensor. FIG. 6 provides a schematic illustration of such an NDIR system, in accordance with an embodiment.

Referring to FIG. 6, an NDIR sensor 600 is shown, in accordance with an embodiment. In an embodiment, the NDIR sensor 600 comprises a photon source 602. For example, the photon source 602 may comprise an IR light source, an ultraviolet (UV) light source, or any other suitable source of electromagnetic radiation. A reflector may direct a greater portion of the IR radiation through the NDIR sensor 600. In an embodiment, the IR radiation may propagate along a gas cell-body 608. The gas cell-body 608 may be a hollow tube in some embodiments. The photon source 602 may be separated from the main gas flow path of the gas cell-body 608 by one or both of a window 606 or an optical filter. In some embodiments, the photon source 602 may be spaced away from the gas cell-body 608 and a fiber optic cable and/or other optics may optically couple the light source 602 to the gas cell-body 608. In an embodiment, a photonic detector system may be provided at an opposite end of the gas cell-body 608 from the light source 602. The photonic detector system may comprise an optical filter 612 and a photo-detector 614 after the optical filter 612. For example, the photo-detector 614 may be an IR photo-detector 614 (in the case an IR light source 602 is used) or a UV photo-detector 614 (in the case a UV light source 602 is used), or a photo-detector 614 for other wavelengths (in the case any other frequency light source 602 is used). In an embodiment, a printed circuit board (PCB) 616 may also be part of the photonic detector system. The PCB 616 may house a controller that comprises processing components, memory components, communication components, and/or the like. As will be described in greater detail below, the controller may implement dynamic correction processes in order to improve the performance and/or accuracy of the NDIR sensor 600. In an embodiment, the photonic detector system may also comprise a heatsink (not shown) that is thermally coupled to the photo-detector 614. While the photo-detector 614 is directly adjacent to the gas cell-body 608 in FIG. 6, it is to be appreciated that optics lines (e.g., optical fibers, lenses, etc.) may be coupled to the gas cell-body 608 (or the filter 612) in order to transport the IR radiation to a photo-detector 614 that is spaced away from the gas cell-body 608. This may be beneficial for thermal control purposes, since the gas cell-body 608 is typically heated, and the photo-detector 614 is temperature sensitive.

In an embodiment an input 604 may be provided proximate to a first end of the gas cell-body 608, and an output 610 may be provided proximate to a second end of the gas cell-body 608. Gas that comprises species 615 (e.g., a precursor species) may flow into the gas cell-body 608 through the input 604, travel along a length of the gas cell-body 608, and exit the NDIR sensor 600 through the output 610. As the IR radiation propagates along the gas cell-body 608, the species 615 may absorb some of the IR radiation. This decreases the magnitude of the signal detected by the photo-detector 614. As described above, the change in magnitude of the signal can be used to determine a concentration of the species 615. In some embodiments, a pressure sensor 618 or pressure transducer may be coupled to one or more of the input 604, the gas cell-body 608, or the output 610.

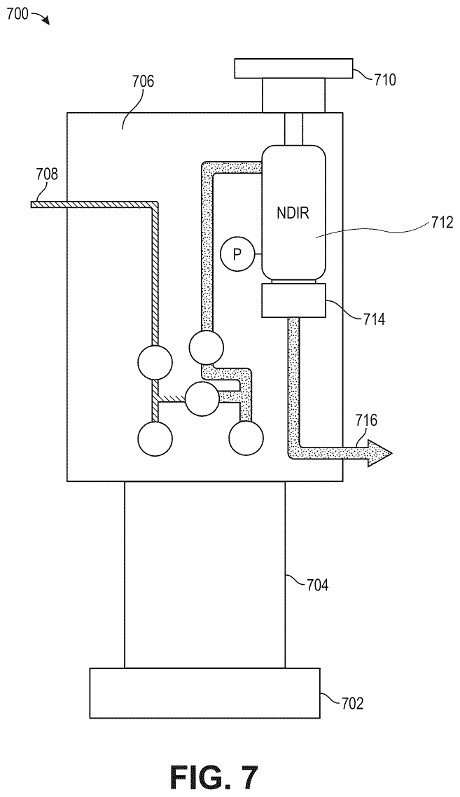

Referring now to FIG. 7, a schematic illustration of a photonic sensor 700, such as an NDIR sensor, is shown, in accordance with an embodiment. As shown, the photonic sensor 700 may comprise an input 708 that feeds a gas (with a precursor species) into a gas cell-body 712. A light source 714 may emit IR radiation through the gas cell-body 712 towards a photo-detector 710 at an opposite end of the gas cell-body 712. An outlet 716 may allow for gas to leave the photonic sensor 700.

In an embodiment, a housing 706 may be provided around the gas cell-body 712. The housing 706 may sometimes be referred to as a hot can. That is, the housing 706 may be a temperature controlled housing. For example, a bottom heater 702 and a side heater 704 may heat the housing 706 in some embodiments. In other embodiments, the bottom heater 702 may be positioned on the ampoule (not shown) in order to control a temperature of the ampoule. Further, while shown as contacting the bottom of the housing 706, one or both of the heaters 702 and 704 may wrap around (or partially around) an outer perimeter of the housing 706. The heating may be used to provide a near constant temperature for the gas cell-body 712 in order to improve accuracy of the photonic sensor 700. Since excess heat degrades the accuracy of the photo-detector 710, the photo-detector 710 may be outside of the housing 706.

As noted above, environmental temperature variations can lead to deviations in the accuracy of the concentration measurements in photonic sensors, such as those described in greater detail herein. Particularly, changes in the heat of the gas cell-body will result in changes to the background IR radiation. This can alter the readings of the photo-detector by providing uncontrolled amounts of IR radiation into the system. Additionally, changes to the temperature of the photo-detector can alter the amount of leakage current (or dark current). As such, the magnitude of the intensity signal will also be altered, and the measured concentration will deviate from an accurate reading.

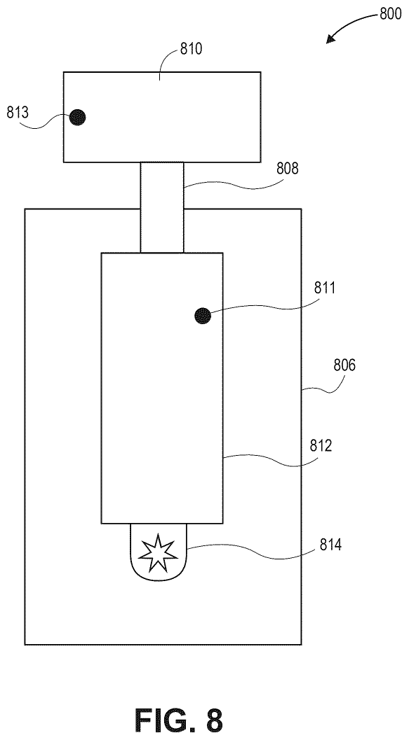

Accordingly, embodiments include a photonic sensor with the added ability to account for these temperature changes. Generally, this is done by providing a temperature sensor on one or both of the gas cell-body or photonic detector system (e.g., on the heatsink). An example of such an embodiment is shown, in accordance with FIG. 8.

Referring now to FIG. 8, a schematic illustration of a photonic sensor 800 is shown, in accordance with an embodiment. In an embodiment, the photonic sensor 800 may be an NDIR sensor or the like. The photonic sensor 800 may comprise a light source 814, such as an IR light source. The light source 814 may be similar to any of the light sources or photon sources described in greater detail herein. The light source 814 may be coupled to a gas cell-body 812 so that the IR radiation propagates along a length of the gas cell-body 812 towards a photonic detector system 810. A connector 808 May couple the gas cell-body 812 to the photonic detector system 810 so that the photonic detector system 810 can be positioned outside of a temperature controlled housing 806 (e.g., a hot can). In an embodiment, the photonic detector system 810 may comprise a photo-detector, a controller, and a heat sink. The photonic detector system 810 may be similar to any of the photonic detector systems described in greater detail herein.

In an embodiment, the photonic sensor 800 may further comprise one or more temperature sensors. For example, a first temperature sensor 811 may be configured to measure a temperature of the gas cell-body 812, and a second temperature sensor 813 may be configured to measure a temperature of the photonic detector system 810. The first temperature sensor 811 may be directly contacting an outer surface of the gas cell-body 812 in some embodiments. The second temperature sensor 813 may be provided on any of the components of the photonic detector system 810. In a particular embodiment, the second temperature sensor 813 is configured to measure a temperature of the heat sink, or the electronic circuit board (PCB) of the sensor. In such an embodiment, the second temperature sensor 813 may directly contact the heat sink. In an embodiment, the first temperature sensor 811 and the second temperature sensor 813 may include any suitable type of temperature sensor. For example, the temperature sensors 811 and 813 may comprise a resistance temperature detector (RTD), a thermocouple, or the like.

In an embodiment, the temperature sensors 811 and 813 may provide temperature readings that can be used to generate a calibration model that is applied to the intensity signal in order to dynamically correct the intensity signal in order to account for temperature variations in the environment. That is, the intensity value is corrected in order to obtain a calibrated absorbance, and the calibrated absorbance can then be used to determine a concentration of the species. In an embodiment, the calibration model may use one or more parameters in order to correct the absorbance signal. In an embodiment, each parameter may be a coefficient, an exponent, or the like within a term that includes the readings from one or both of the temperature sensors 811 and 813. These calibration models may be mathematical equations that are linear or non-linear. It is to be appreciated that single parameter solutions and multi-parameter solutions may both include linear or non-linear calibration models. For example, a non-linear calibration model with a single parameter may include the single parameter that is a coefficient in a first term and an exponent in a second term, a non-linear calibration model with multiple parameters may include a first parameter as a coefficient in a first term and a second parameter as an exponent in a second term, a linear calibration model with a single term may include a single parameter as a coefficient in a term, or a linear calibration model with multiple parameters may include a first parameter as a coefficient in a first term and a second parameter as a coefficient in a second term (where the second term is added or subtracted from the first term. Non-linear correction models may also be generated through the inclusion of a single term that includes readings from both of the temperature sensors 811 and 813 that are multiplied together and further multiplied by a coefficient parameter.

In an embodiment, a single parameter calibration model may take the form of Equation 2.

$${V}_{L C} = M \times {T}_{Heat Sink} + B \qquad Equation 2$$

In Equation 2, V_{LC} is the leakage current (or dark current) signal, M is a constant value parameter, T_{Heat Sink} is the temperature of the heat sink, and B is a constant value. While T_{Heat Sink} is used in Equation 2, the temperature of the gas cell-body may replace the temperature of the heat sink in some embodiments.

In an embodiment, a multi-parameter calibration model may take the form of Equation 3.

$${V}_{L C} = {M}_{Heat Sink} \times {T}_{Heat Sink} + {M}_{Cell Body} \times {T}_{Cell Body} + B \qquad Equation 3$$

In Equation 3, V_{LC} is the leakage current (or dark current) signal, M_{Heat Sink} is a first constant value parameter, T_{Heat Sink} is the temperature of the heat sink, M_{Cell-Body} is a second constant value parameter, T_{Cell-Body} is the temperature of the cell-body, and B is a constant value.

In an embodiment, a multi-parameter calibration model may take the form of Equation 4.

$${V}_{L C} = {M}_{Heat Sink} \times {T}_{Heat Sink} + {M}_{Cell Body} \times {T}_{Cell Body} + {M}_{C o rrelation} \times {T}_{Heat Sink} \times {T}_{Cell Body} + B \qquad Equation 4$$

In Equation 4, VDC is the leakage current (or dark current) signal, M_{Heat Sink} is a first constant value parameter, T_{Heat Sink} is the temperature of the heat sink, M_{Cell-Body} is a second constant value parameter, T_{Cell-Body} is the temperature of the cell-body, M_{Correlation} is a third constant value parameter related to the cross-correlation between the heat sink and the cell-body, and B is a constant value.

In an embodiment, the calibration model may be applied to the intensity signal with any mathematical operation or operations. For example, the calibration model may be an offset that is added or subtracted to/from the intensity signal. The calibration model may also be a scaling factor that is multiplied with the intensity signal.

The calibration models can be continuously updated during the operation of the photonic sensor to allow for dynamic correction. In some embodiments, the dynamic correction allows for continuous operation of the photonic sensor, as opposed to relying a pulsed operation (as is described in greater detail above). In an embodiment, the dynamic correction may be implemented on the controller of the photonic sensor. The dynamic correction may be embodied as software, firmware, hardware, or any combination thereof.

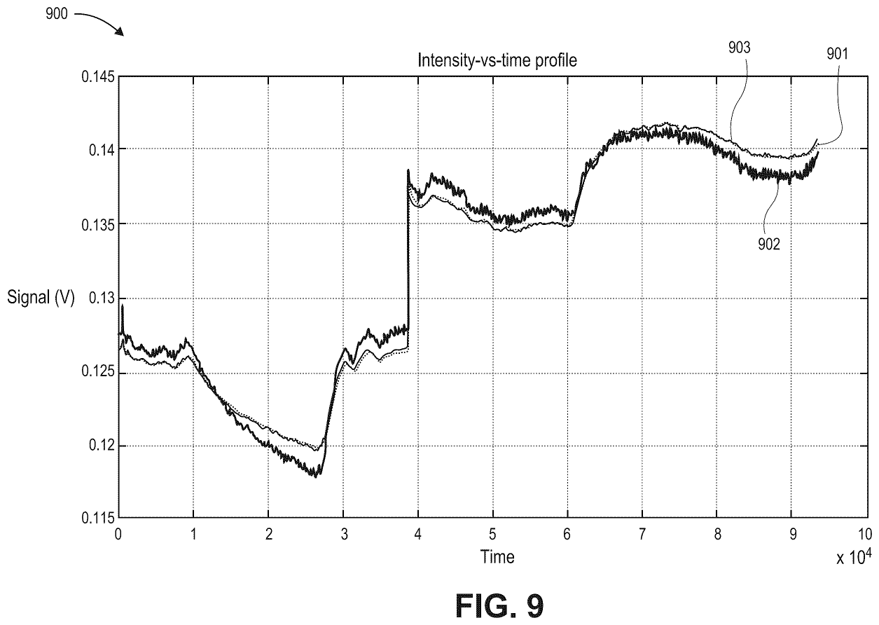

Referring now to FIG. 9, a plot 900 of the intensity signal over time is shown. The first line 901 is the raw intensity data, the second line 902 is the intensity signal after a single parameter calibration model is applied, and the third line 903 is the intensity signal after a multi-parameter calibration model is applied. As shown, the single parameter calibration model does a good job of matching the true value of the intensity data. However, the multi-parameter calibration model provides even greater improvement in matching the true value of the intensity data. The multi-parameter calibration model used in FIG. 9 may be similar to the one shown in Equation 4. However, adding even more terms and/or parameters to the calibration model may further improve the matching in some embodiments. That is, the calibration model is not limited to one, two, or three parameters. Instead, the calibration model may generally be described as comprising one or more parameters based on temperature inputs of the system.

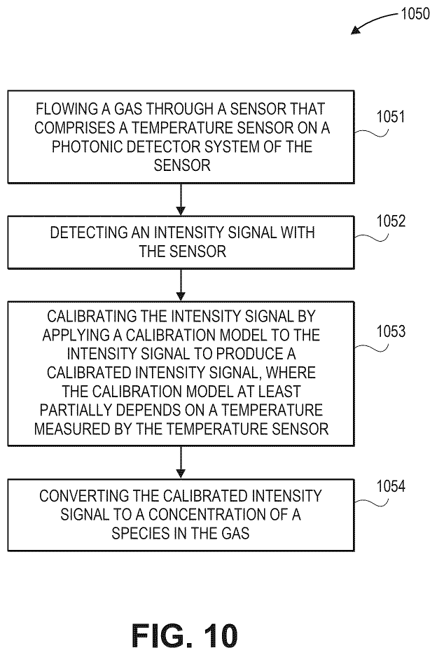

Referring now to FIG. 10, a process flow diagram of a process 1050 for providing dynamic correction of a photonic sensor is shown, in accordance with an embodiment. In an embodiment, the process 1050 may begin with operation 1051, which comprises flowing a gas through a sensor that comprises a temperature sensor on photonic detector system of the sensor. In an embodiment, the sensor may be a photonic sensor, such as an NDIR sensor. The sensor may be similar to any of the sensors described in greater detail herein. In an embodiment, the photonic detector may be similar to any of the photonic detectors described in greater detail herein. For example, the photonic detector may be an IR detector.

In an embodiment, the process 1050 may continue with operation 1052, which comprises detecting an intensity signal with the sensor. The intensity signal may be a signal that is correlated to the amount of electromagnetic radiation (e.g., IR radiation) that passes through the sensor without being absorbed by the gas flowing through the sensor. That is, higher intensity signal magnitudes will correlate to a smaller amount of absorbance in the sensor.

In an embodiment, the process 1050 may continue with operation 1053, which may comprise calibrating the intensity signal by applying a calibration model to the mathematical equation for the intensity signal to produce a calibrated intensity signal. In an embodiment, the calibration model may at least partially depend on a temperature measured by the temperature sensor. In an embodiment, the calibration model may be similar to any of the calibration models described in greater detail herein. The calibration model may be applied to the intensity signal through any mathematical operation.

In an embodiment, the process 1050 may continue with operation 1054, which comprises converting the calibrated intensity signal to a concentration of a species in the gas. For example, the species may be a precursor for a processing operation (e.g., deposition, etching, etc.) within a chamber. In an embodiment, the conversion may be made through the use of the Beer-Lambert Law.

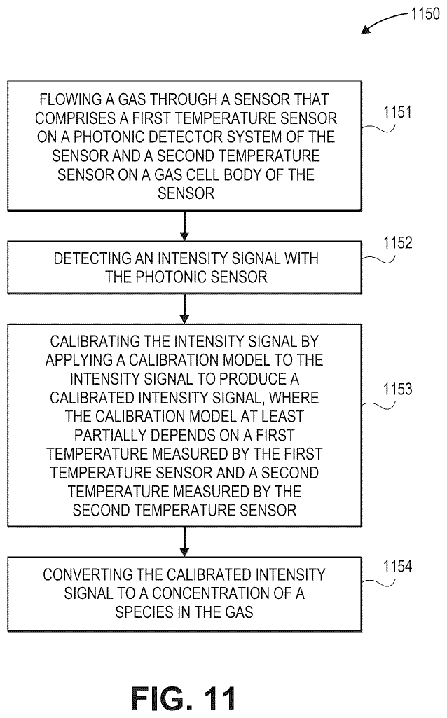

Referring now to FIG. 11, a process flow diagram of a process 1150 for providing dynamic correction of a photonic sensor is shown, in accordance with an embodiment. In an embodiment, the process 1150 may begin with operation 1151, which comprises flowing a gas through a sensor that comprises a first temperature sensor on a photonic detector system (e.g., on the heat sink or the PCB of the photo-detector) of the sensor and a second temperature sensor on a gas cell-body of the sensor. In an embodiment, the sensor may be a photonic sensor, such as an NDIR sensor. The sensor may be similar to any of the sensors described in greater detail herein. In an embodiment, the photonic detector may be similar to any of the photonic detectors described in greater detail herein. For example, the photonic detector may be an IR detector.

In an embodiment, the process 1150 may continue with operation 1152, which comprises detecting an intensity signal with the sensor. The intensity signal may be a signal that is correlated to the amount of electromagnetic radiation (e.g., IR radiation) that passes through the sensor without being absorbed by the gas flowing through the sensor. That is, higher intensity signal magnitudes will correlate to a smaller amount of absorbance in the sensor.

In an embodiment, the process 1150 may continue with operation 1153, which may comprise calibrating the intensity signal by applying a calibration model to the mathematical equation for the intensity signal to produce a calibrated intensity signal. In an embodiment, the calibration model may at least partially depend on a first temperature measured by the first temperature sensor and a second temperature measured by the second temperature sensor. In an embodiment, the calibration model may be similar to any of the calibration models described in greater detail herein. The calibration model may be applied to the intensity signal through any mathematical operation.

In an embodiment, the process 1150 may continue with operation 1154, which comprises converting the calibrated intensity signal to a concentration of a species in the gas. For example, the species may be a precursor for a processing operation (e.g., deposition, etching, etc.) within a chamber. In an embodiment, the conversion may be made through the use of the Beer-Lambert Law.

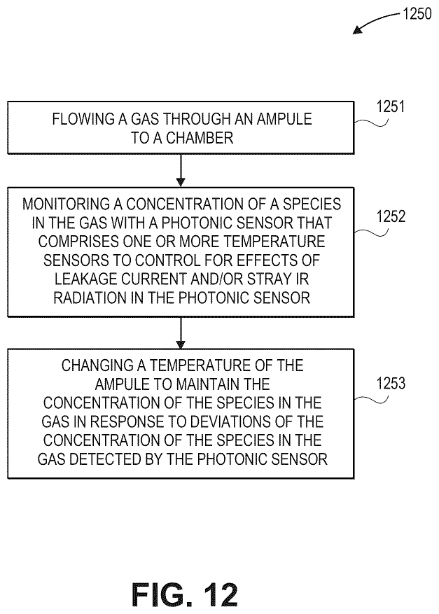

Referring now to FIG. 12, a process 1250 for controlling a dose of a gas species flowing into a chamber is shown, in accordance with an embodiment. In an embodiment, the process 1250 may begin with operation 1251, which comprises flowing a gas from an ampule to a chamber. In an embodiment, the ampule may be similar to any of the ampules described in greater detail herein. The chamber may be a processing chamber. For example, the chamber may be used for deposition processes, etching processes, or the like. In an embodiment, the gas may comprise a carrier gas and a species (e.g., a precursor).

In an embodiment, the process 1250 may continue with operation 1252, which comprises monitoring a concentration of the species in the gas with a photonic sensor that comprises one or more temperature sensors to control for effects of leakage current and/or stray IR radiation in the photonic sensor. For example, the one or more temperature sensors may provide temperature measurements that can be used to derive the calibration models that are used to correct the intensity signals, similar to embodiments described in greater detail herein.

In an embodiment, the process 1250 may continue with operation 1253, which comprises changing a temperature of the ampule to maintain the concentration of the species in the gas in response to deviations of the concentrations of the species in the gas detected by the photonic sensor. For example, operation 1253 may aim to keep the flux (or dose) of the species applied to the chamber within the LCL and UCL of a particular process recipe design. Such a process allows for more efficient use of the ampoule, and provides a more uniform processing result in the chamber over time.

Embodiments disclosed herein explicitly describe process monitoring for flowing gasses into semiconductor processing chambers (e.g., within plasma chambers for deposition processes, etching processes, etc.) However, it is to be appreciated that photonic sensors have applicability to many different monitoring applications. For example, volatile chemicals in the environment, breathing system, aircraft interior air quality/gas concentration and/or the like. That is, photonic sensors with additional temperature sensors to control for leakage current and background (or stray) IR radiation through the application of dynamic control and/or calibration can be used in many different applications.

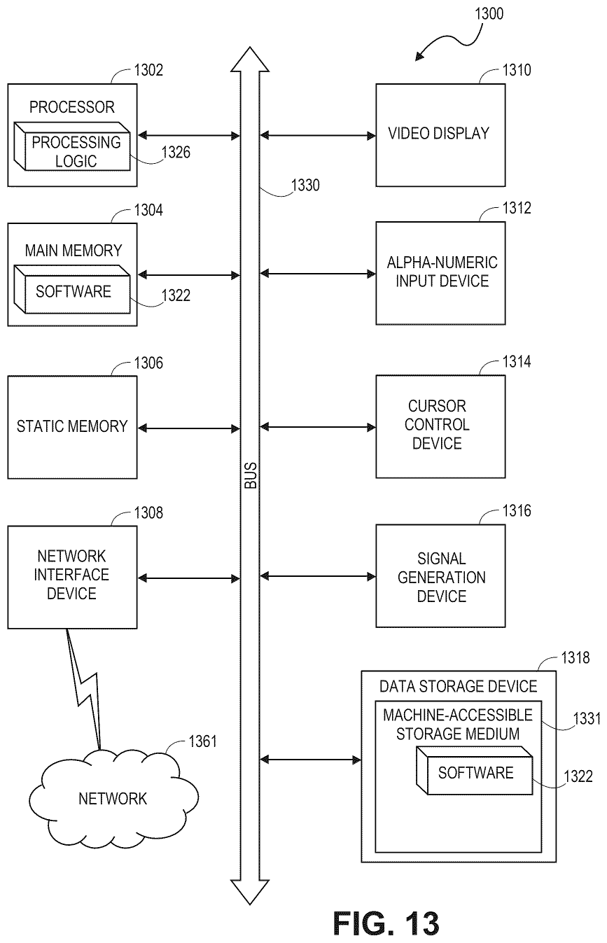

Referring now to FIG. 13, a block diagram of an exemplary computer system 1300 of a processing tool is illustrated in accordance with an embodiment. In an embodiment, computer system 1300 is coupled to and controls processing in the processing tool. The computer system 1300 may be communicatively coupled to one or more vapor concentration sensor modules, such as those disclosed herein. The computer system 1300 may utilize outputs from the one or more vapor concentration sensor modules in order to modify one or more parameters, such as, for example, processing recipe parameters, cleaning schedules for the processing tool, component replacement determinations, and the like.

Computer system 1300 may be connected (e.g., networked) to other machines in a Local Area Network (LAN), ECAT, an intranet, an extranet, or the Internet. Computer system 1300 may operate in the capacity of a server or a client machine in a client-server network environment, or as a peer machine in a peer-to-peer (or distributed) network environment. Computer system 1300 may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated for computer system 1300, the term “machine” shall also be taken to include any collection of machines (e.g., computers) that individually or jointly execute a set (or multiple sets) of instructions to perform any one or more of the methodologies described herein.

Computer system 1300 may include a computer program product, or software 1322, having a non-transitory machine-readable medium having stored thereon instructions, which may be used to program computer system 1300 (or other electronic devices) to perform a process according to embodiments. A machine-readable medium includes any mechanism for storing or transmitting information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices, etc.), a machine (e.g., computer) readable transmission medium (electrical, optical, acoustical or other form of propagated signals (e.g., infrared signals, digital signals, etc.)), etc.

In an embodiment, computer system 1300 includes a system processor 1302, a main memory 1304 (e.g., read-only memory (ROM), flash memory, dynamic random access memory (DRAM) such as synchronous DRAM (SDRAM) or Rambus DRAM (RDRAM), etc.), a static memory 1306 (e.g., flash memory, static random access memory (SRAM), etc.), and a secondary memory 1318 (e.g., a data storage device, cloud storage), which communicate with each other via a bus 1330.

System processor 1302 represents one or more general-purpose processing devices such as a microsystem processor, central processing unit, or the like. More particularly, the system processor may be a complex instruction set computing (CISC) microsystem processor, reduced instruction set computing (RISC) microsystem processor, very long instruction word (VLIW) microsystem processor, a system processor implementing other instruction sets, or system processors implementing a combination of instruction sets. System processor 1302 may also be one or more special-purpose processing devices such as an application specific integrated circuit (ASIC), a field programmable gate array (FPGA), a digital signal processor (DSP) system, network system processor, or the like. System processor 1302 is configured to execute the processing logic 1326 for performing the operations described herein.

The computer system 1300 may further include a system network interface device 1308 for communicating with other devices or machines. The computer system 1300 may also include a video display unit 1310 (e.g., a liquid crystal display (LCD), a light emitting diode display (LED), or a cathode ray tube (CRT)), an alphanumeric input device 1312 (e.g., a keyboard), a cursor control device 1314 (e.g., a mouse), and a signal generation device 1316 (e.g., a speaker).

The secondary memory 1318 may include a machine-accessible storage medium 1331 (or more specifically a computer-readable storage medium) on which is stored one or more sets of instructions (e.g., software 1322) embodying any one or more of the methodologies or functions described herein. The software 1322 may also reside, completely or at least partially, within the main memory 1304 and/or within the system processor 1302 during execution thereof by the computer system 1300, the main memory 1304 and the system processor 1302 also constituting machine-readable storage media. The software 1322 may further be transmitted or received over a network 1361 via the system network interface device 1308. In an embodiment, the network interface device 1308 may operate using RF coupling, optical coupling, acoustic coupling, or inductive coupling.

While the machine-accessible storage medium 1331 is shown in an exemplary embodiment to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the machine and that cause the machine to perform any one or more of the methodologies. The term “machine-readable storage medium” shall accordingly be taken to include, but not be limited to, solid-state memories, and optical and magnetic media.

Thus, embodiments of the present disclosure include photonic sensors with additional temperature sensors to control for leakage current and stray IR radiation through the application of dynamic control and/or calibration.

The above description of illustrated implementations of embodiments of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize.

These modifications may be made to the disclosure in light of the above detailed description. The terms used in the following claims should not be construed to limit the disclosure to the specific implementations disclosed in the specification and the claims. Rather, the scope of the disclosure is to be determined entirely by the following claims, which are to be construed in accordance with established doctrines of claim interpretation.

What is claimed is:

1. An apparatus, comprising:
a gas cell-body with a first end and a second end;
a light source coupled to the first end of the gas cell-body, wherein the light source is configured to emit electromagnetic radiation through the gas cell-body;
a photonic detector system coupled to the second end of the gas cell-body;
a housing around the gas cell-body that is temperature controlled, wherein the photonic detector system is outside the housing; and
a temperature sensor configured to measure a temperature of the photonic detector system or a temperature of the gas cell-body.

2. The apparatus of claim 1, further comprising a second temperature sensor, wherein the second temperature sensor is configured to measure one of the temperature of the photonic detector system or the temperature of the gas cell-body, and wherein the temperature sensor is configured to measure an other one of the temperature of the photonic detector system or the temperature of the gas cell-body.

3. The apparatus of claim 1, wherein the photonic detector system comprises:
a photo-detector;
a printed circuit board (PCB);
a heat sink, wherein the temperature sensor is configured to measure a temperature of the heat sink or the PCB; and
a controller.

4. The apparatus of claim 1, wherein the photonic detector system comprises an infrared photo-detector.

5. The apparatus of claim 1, further comprising:
an inlet proximate to the first end the gas cell-body for flowing a gas into the gas cell-body; and
an outlet proximate to the second end of the gas cell-body for flowing the gas out of the gas cell-body.

6. The apparatus of claim 5, wherein the inlet is fluidically coupled to an ampoule, and wherein the outlet is fluidically coupled to a processing chamber.

7. The apparatus of claim 1, wherein the apparatus is a non-dispersive infrared (NDIR) sensor.

8. The apparatus of claim 1, further comprising:
a heater configured to heat the housing.

9. The apparatus of claim 1, wherein the temperature sensor is a resistance temperature detector (RTD) or a thermocouple.

10. The apparatus of claim 1, wherein the photonic detector system comprises a controller, wherein the controller is configured to use a temperature measurement from the temperature sensor to calibrate an intensity signal to account for one or both of leakage current or background radiation.

11. A method for generating a calibrated intensity signal, comprising:
flowing a gas through a sensor that comprises a temperature sensor on a photo-detector system of the sensor;
detecting an intensity signal with the sensor; and
calibrating the intensity signal by applying a calibration model to the intensity signal to produce the calibrated intensity signal, wherein the calibration model depends at least partially on a temperature measured by the temperature sensor.

12. The method of claim 11, further comprising:
converting the calibrated intensity signal to a concentration of a species in the gas.

13. The method of claim 11, wherein the sensor further comprises a second temperature sensor on a gas cell-body of the sensor, and wherein the calibration model at least partially depends on a temperature measured by the second temperature sensor.

14. The method of claim 13, wherein the calibration model is a non-linear mathematical function of the temperatures measured by the temperature sensor and the second temperature sensor.

15. The method of claim 13, wherein the calibration model comprises a cross-correlation term corresponding to the temperature measured by the temperature sensor and the temperature measured by the second temperature sensor.

16. The method of claim 11, wherein the calibration model is a linear function.

17. The method of claim 11, wherein the sensor is configured for operation with electromagnetic radiation from UV wavelengths to IR wavelengths.

18. A method for controlling a flow of a gas into a chamber, comprising:
flowing the gas through an ampule to the chamber;
monitoring a concentration of a species in the gas with a photonic sensor that comprises one or more temperature sensors to control for effects of leakage current and/or background radiation in the photonic sensor; and
changing a temperature of the ampule to maintain the concentration of the species in the gas in response to deviations of the concentration of the species in the gas detected by the photonic sensor.

19. The method of claim 18, wherein a first temperature sensor is configured to measure a temperature of a heat sink of a photonic sensor, and wherein a second temperature sensor is configured to measure a temperature of a gas cell-body of the photonic sensor.

20. The method of claim 18, wherein the photonic sensor is a non-dispersive infrared (NDIR) sensor or a non-dispersive ultraviolet (NDUV) sensor.
